(19) United States
(12) Patent Application Publication
(10) Pub. No.: US 2018/0240098 A1
(43) Pub. Date: Aug. 23, 2018

(54) PAYMENT METHOD AND SYSTEM OF VEHICLE

(71) Applicants: HYUNDAI MOTOR COMPANY, SEOUL (KR); KIA MOTORS CORPORATION, SEOUL (KR)

(72) Inventors: Hye Won YOU, Seoul (KR); Keun Hang HEO, Yongin-si (KR)

(73) Assignees: HYUNDAI MOTOR COMPANY, SEOUL (KR); KIA MOTORS CORPORATION, SEOUL (KR)

(21) Appl. No.: 15/814,008

(22) Filed: Nov. 15, 2017

(30) Foreign Application Priority Data
Feb. 17, 2017 (KR) 10-2017-0021825

(51) Int. Cl. G06Q 20/32; G06Q 20/40; H04W 4/02

(52) U.S. Cl. CPC G06Q 20/3224; H04W 4/021; G06Q 20/325; G06Q 20/40

(57) ABSTRACT

The present disclosure provides a method of making payment in a vehicle. Forms of the method may include: determining, with a head unit (H/U), whether a user of the vehicle is either a main user or a sub user; receiving, with the H/U, location information of the vehicle; determining, with the H/U, a category of a point of interest (POI) and payment rights based on the location information of the vehicle and the user of the vehicle, wherein the category of the POI is determined based on the location information of the vehicle and the payment rights is predetermined depending on the category of the POI; and attempting to make payment, with the H/U, through a payment server based on the payment rights.

### CROSS-REFERENCE TO RELATED APPLICATION

The present application claims priority to and the benefit of Korean Patent Application No. 10-2017-0021825, filed on Feb. 17, 2017, which is incorporated herein by reference in its entirety.

### FIELD

The present disclosure relates to a payment method and system of a vehicle.

### BACKGROUND

The statements in this section merely provide background information related to the present disclosure and may not constitute prior art.

Geofence technology refers to technology for storing location information of a vehicle when the vehicle deviates from an area predetermined by a user or a protector, and notifying the user or the protector with a message indicating that the vehicle is outside geofence range based on the stored location information.

Such geofence technology efficiently notifies the user of the predetermined area to inhibit the vehicle from entering a prohibited area and from deviating the predetermined area.

Recently, simple payment systems using a virtual account in a vehicle have been widely used.

However, in today's geofence technology, it may be difficult to manage a payment system of a user who drives a vehicle.

### SUMMARY

The present disclosure provides a payment method and system of a vehicle, which are capable of identifying payment rights according to users who use the payment system and making payment based on a category of a point of interest (POI) of a user.

A method of making payment in a vehicle may include: determining, with a head unit (H/U), whether a user of the vehicle is either a main user or a sub user, receiving, with the H/U location information of the vehicle; determining, with the H/U, a category of a point of interest (POI) and payment rights based on the location information of the vehicle and the user of the vehicle, wherein the category of the POI is determined based on the location information of the vehicle, and wherein the payments rights is predetermined depending on the category of the POI; and attempting to make payment, with the H/U, through a payment server based on the payment rights.

In another aspect of the present disclosure, a system for making payment in a vehicle may include: a head unit (H/U) configured to determine whether a user of the vehicle is either a main user or a sub user, to receive location information of the vehicle, to determine a category of a point of interest (POI) and payment rights based on the location information of the vehicle and the user of the vehicle, wherein the category of the POI is determined based on the location information of the vehicle, and wherein the payment rights is predetermined depending on the category of the POI; and a payment server, wherein the H/U attempts to make payment through the payment server based on the payment rights.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram showing the configuration of a payment system of a vehicle;

FIG. 2 is a flowchart illustrating a payment method of a vehicle;

FIG. 3 is a diagram showing a payment method of a vehicle;

FIG. 4 is a diagram showing a first payment success example;

FIG. 5 is a diagram showing a second payment success example; and

FIG. 6 is a diagram showing a first payment failure example.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure relates to a payment method and system of a vehicle, which are capable of distinguishing between a main user and a sub user of the vehicle to provide payment rights to each user such that a user who uses this vehicle makes payment within a predetermined area.

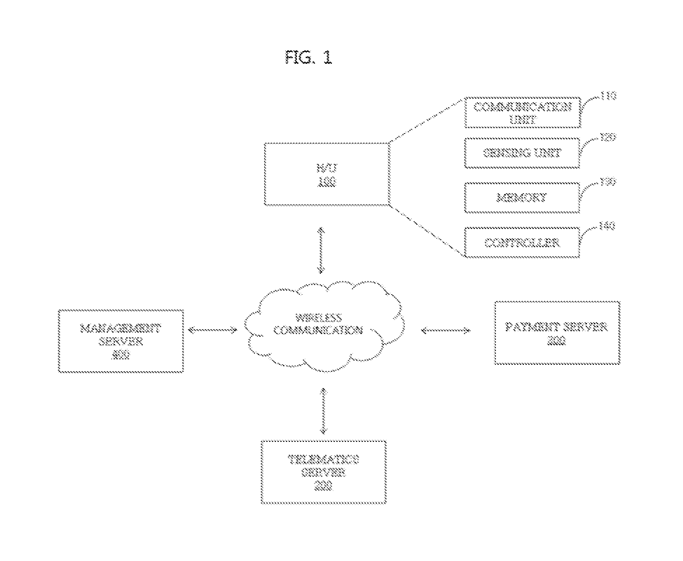

FIG. 1 is a block diagram showing the configuration of a payment system of a vehicle in some forms of the present disclosure.

Referring to FIG. 1, the payment system of the vehicle in some forms of the present disclosure may include a head unit (H/U) 100 mounted in the vehicle, a telematics server 200, a payment server 300, and a management server 400.

The H/U 100 may include a communication unit 110, a sensing unit 120, a memory 130 and a controller 140.

The communication unit 110 refers to a wireless communication module and may be provided inside or outside the vehicle. The communication unit 110 transmits and receives a wireless signal over a communication network according to wireless Internet technologies.

Examples of the wireless Internet technology may include WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), etc. The communication unit 110 transmits and receives data according to at least one wireless Internet technology including Internet technologies other than the above-described technologies. For example, the communication unit 110 may exchange data with an external server in a wireless manner.

The communication unit 110 may output vehicle information including vehicle speed information, vehicle traveling direction information and vehicle location information to the external server. The communication unit 110 may output the vehicle information to the external server at a predetermined period.

The communication unit 110 may output a login request signal to the telematics server 200. The communication unit 110 may output payment account generation information to the payment server 300. The communication unit 110 may output payment account deposit information to the payment server 300. The communication unit 110 may output payment request information to the payment server 300. The payment request information may include shopping malls, gas stations, restaurants, etc.

The communication unit 110 may receive fuel information through a refueling sensor of the sensing unit 120.

The sensing unit 120 may receive the location information of the vehicle through a GPS module. The sensing unit 120 may include a fuel sensor.

The memory 130 is electrically connected to the controller 140. The memory 130 may store basic data of a unit, control data for operational control of a unit and input/output data. The memory 130 may include various storage devices such as a ROM, a RAM, an EPROM, a flash drive or a hard drive. The memory 130 may store a variety of data for overall operation of the vehicle, such as programs for processing or control of the controller 140.

The memory 130 may store a category of a POI configured by the main user. The memory 130 may store personal information of the user of the vehicle. The personal information may include fingerprint, iris, voice, etc.

The controller 140 may configure the category of the POI of the user in the vehicle. Only the main user may configure the category of the POI. The sub user may not configure the category of the POI.

The controller 140 may determine the mileage range of the vehicle based on the fuel information received from the communication unit 110.

The controller 140 may calculate a geofence area including a radius set to a predetermined distance from the location of the vehicle based on the current location of the vehicle received from the sensing unit 120.

The controller 140 may determine whether the category of the POI corresponding to the location information of the vehicle and predetermined payment rights based on the category are configured.

The category of the POI corresponding to the location information of the vehicle may include geofence information according to a user registered with the H/U 100.

The payment rights may be pre-configured by the main user registered with the management server 300. The payment rights may be differently configured depending on the main user and the sub user.

The controller 140 may configure the payment rights based on the category of the POI. The controller 140 may determine the payment rights in the POI of the geofence area with respect to the sub user.

The controller 140 may try to make payment at any places capable of processing payment in the geofence area with respect to the main user.

When payment success information is received from the payment server 300, the controller 140 may generate a control signal for notifying the main user of a success message.

When payment failure information is received from the payment server 300, the controller 140 may generate a control signal for notifying the main user of a failure message.

The controller 140 may be implemented by one or more microprocessors operating by a set program and the set program may include a series of commands for performing the steps included in the payment system and method of the vehicle in some forms of the present disclosure.

The telematics server 200 may transmit and receive information to and from the H/U 100, the payment server 300 and the management server 400 through wireless communication.

The telematics server 200 may receive login information from the H/U 100. The telematics server 200 may transmit oil price information to and receive oil price information from the H/U 100. The telematics server 200 may transmit the payment rights configured by the main user to the H/U 100.

When the sub user requests payment, the telematics server 200 may notify the main user that the sub user has requested the payment. When a sub user requests payment without the payment rights, the telematics server 200 may enable the main server to configure the payment rights using wireless communication.

The payment server 300 may transmit and receive information to the H/U 100, the telematics server 200 and the management server 400 through wireless communication. The payment server 300 may generate a virtual account according to an account generation request of the H/U 100. The payment server 300 may make payment according to a payment request of the H/U 100.

The management server 400 may transmit and receive information to and from the H/U 100, the telematics server 200 and the payment server 300 through wireless communication. The management server 400 may register the main user and the sub user. The management server 400 may store member registration information and user registration information.

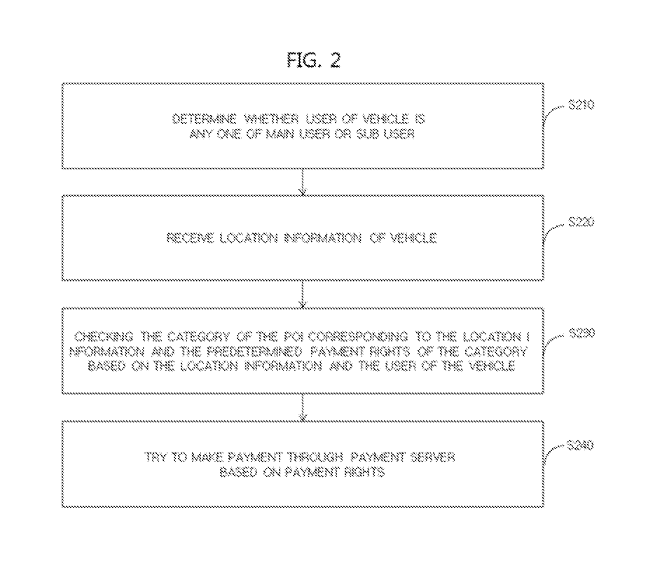

FIG. 2 is a flowchart illustrating a payment method of a vehicle in some forms of the present disclosure.

In FIG. 2, the payment method of the vehicle may include determining whether the user of the vehicle is either the main user or the sub user (S210), receiving the location information of the vehicle (S220), checking the category of the POI corresponding to the location information and the predetermined payment rights of the category based on the location information and the user of the vehicle (S230), and trying to make payment through the payment server based on the payment rights (S240).

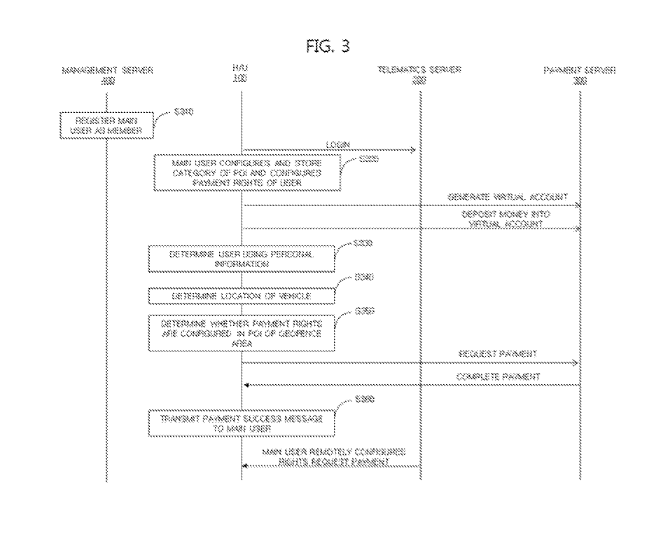

FIG. 3 is a diagram showing a payment method of a vehicle in some forms of the present disclosure.

In FIG. 3, the management server 400 may register the main user as a member and store information (S310).

The H/U 100 may log in to the telematics server 200 through the communication unit 110 in a wireless communication manner. The telematics server 200 may receive the information on the main user from the management server 400.

The H/U 100 may store configuration information and the payment rights of the user in the memory 130 based on the category of the POI configured by the main user (S320). The main user and the sub user may have the payment rights.

The H/U 100 may make a request for generating a virtual account from the payment server 300 when the rights of the main user and the sub user are configured. The payment server 300 may generate the virtual account according to the account generation request of the H/U 100. The virtual account may be used for payment using the vehicle.

The H/U 100 may deposit money into the virtual account stored in the payment server 300. The H/U 100 may use money deposited in the virtual account upon making payment. The H/U 100 may determine the user based on the personal information stored in the memory 130, upon logging in to the payment system through the telematics server 200 (S330).

The H/U 100 may determine the location of the vehicle when the user who logs in to the payment system is determined (S340). The location of the vehicle may be received from the GPS device mounted in the vehicle.

The H/U 100 may determine whether the payment rights are configured in the POI of the predetermined geofence area based on the received GPS location information (S350).

The H/U 100 may try to make payment through the payment server upon determining that the payment rights are configured.

If payment is successfully made, the payment server 300 may transmit payment complete information to the H/U 100. If payment is completed, the H/U 100 may transmit a payment success message to the main user (S360). The message may be transmitted through a short message service (SMS).

If payment fails, the payment server 300 may transmit payment failure information to the H/U 100. The H/U 100 may transmit payment failure message to the main user.

When the main user receives the payment failure message, the main user may transmit payment right information to the H/U 100 through the telematics server 200 to configure the payment rights of the sub user.

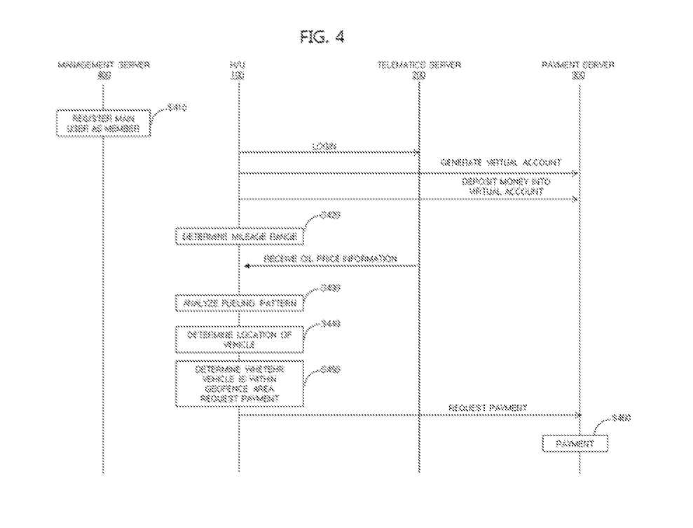

FIG. 4 is a diagram showing a first payment success example in some forms of the present disclosure.

In FIG. 4, the management server 400 may register the main user as a member and store information (S410).

The H/U 100 may log in to the telematics server 200 through the communication unit 110 in a wireless communication manner. The H/U 100 may make a request for generating a virtual account from the payment server 300 upon logging in to the telematics server 200. The payment server 300 may generate the virtual account according to the account generation request of the H/U 100. The virtual account may be used for payment using the vehicle. The H/U 100 may deposit money into the virtual account stored in the payment server 300.

The H/U 100 may receive fuel information from the sensing unit 120. The controller 140 may determine a mileage range based on the fuel information (S420). The mileage range may be determined based on the location of a gas station within the geofence area.

The H/U 100 may receive oil price information from the gas station within the mileage range through the telematics server 200.

The H/U 100 may set the amount of fuel according to a user request. The amount of fuel may be set based on the oil price information.

The H/U 100 may analyze a fueling pattern of the user based on the setting of the amount of fuel (S430). The fueling pattern may increase fuel efficiency based on the setting of the amount of fuel and the fueling pattern of the user. The H/U 100 may determine when fueling is necessary by analyzing the fueling pattern.

The H/U 100 may determine the location of the vehicle upon determining when fueling is necessary (S440). The location of the vehicle may be received from the GPS device mounted in the vehicle.

The H/U 100 may determine whether the location of the vehicle is within the geofence area based on the GPS information.

If the location of the vehicle is within the geofence area, the H/U may make a request for payment for fueling from the payment server 300.

The payment server 300 may make payment for fueling according to the payment request.

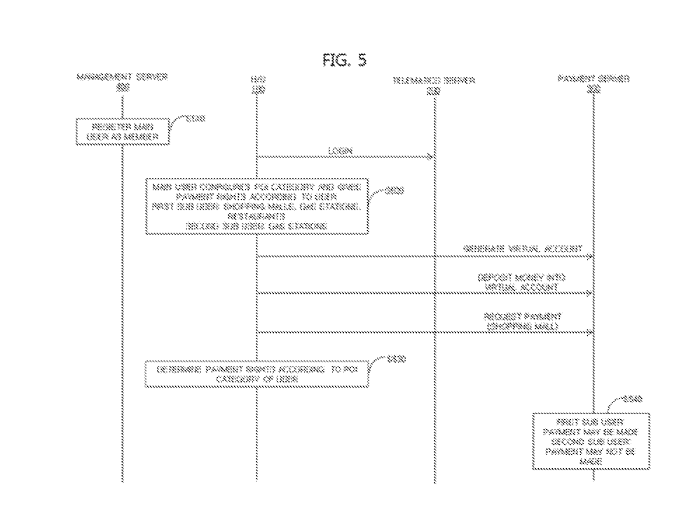

FIG. 5 is a diagram showing a second payment success example in some forms of the present disclosure.

In FIG. 5, the management server 400 may register the main user as a member and store information (S510).

The H/U 100 may log in to the telematics server 200 through the communication unit 110 in a wireless communication manner. The telematics server 200 may receive the information on the main user from the management server 400.

The H/U 100 may store configuration information and the payment rights of the user in the memory 130 based on the category of the POI configured by the main user (S520). The main user and the sub user may have the payment rights. The main user may register a plurality of sub users.

For example, the H/U 100 may store the category of the POI of a first user configured by the main user. The category of the POI of the first sub user may include shopping malls, gas stations and restaurants. The H/U 100 may store the category of the POI of a second user configured by the main user. The category of the POI of the second sub user may include gas stations.

The H/U 100 may make a request for generating a virtual account from the payment server 300 when the rights of the main user and the sub user are configured. The payment server 300 may generate the virtual account according to the account generation request of the H/U 100. The virtual account may be used for payment using the vehicle.

The H/U 100 may deposit money into the virtual account stored in the payment server 300. The H/U 100 may use money deposited in the virtual account upon making payment. The H/U 100 may request payment from the payment server 300 with respect to a shopping mall.

The H/U 100 may determine the payment rights of the user based on the category of the POI stored in the memory 130 (S530). The category of the POI may include whether the vehicle is within the predetermined geofence area. The category of the POI may be equal to the geofence.

If the user who has requested payment is the first sub user, the payment server 300 may make payment with respect to the shopping mall based on the category of the POI.

If the user who has requested payment is the second sub user, the payment server 300 may not make payment with respect to the shopping mall based on the category of the POI of the second sub user.

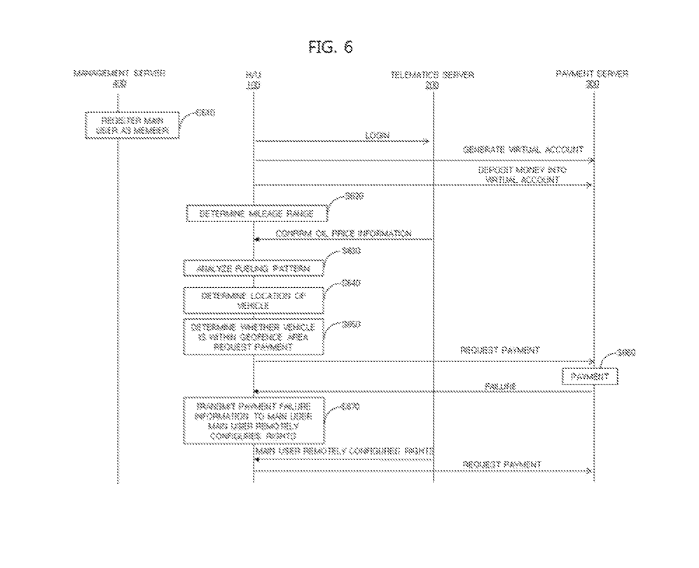

FIG. 6 is a diagram showing a first payment failure example in some forms of the present disclosure.

In FIG. 6, the management server 400 may register the main user as a member and store information (S610).

The H/U 100 may log in to the telematics server 200 through the communication unit 110 in a wireless communication manner. The H/U 100 may make a request for generating a virtual account from the payment server 300 upon logging in to the telematics server 200. The payment server 300 may generate the virtual account according to the account generation request of the H/U 100. The virtual account may be used for payment using the vehicle. The H/U 100 may deposit money into the virtual account stored in the payment server 300.

The H/U 100 may receive fuel information from the sensing unit 120. The controller 140 may determine a mileage range based on the fuel information (S620).

The H/U 100 may receive oil price information from the gas station within the mileage range through the telematics server 200.

The H/U 100 may set the amount of fuel according to a user request. The amount of fuel may be set based on the oil price information.

The H/U 100 may analyze the fueling pattern of the user based on the setting of the amount of fuel (S630).

The H/U 100 may determine the location of the vehicle when the fueling pattern is analyzed (S640). The location of the vehicle may be received from the GPS device mounted in the vehicle.

The H/U 100 may determine whether the location of the vehicle is within the geofence area based on the GPS information (S650).

Upon determining that the location of the vehicle is within the geofence area, a request for payment for fueling may be made from the payment server 300.

The payment server 300 may make payment for fueling according to the payment request (S660).

If payment fails, the payment server may transmit payment failure information to the H/U 100.

The H/U 100 may transmit the payment failure information of the sub user to the main user through a message (S670). The message may be transmitted through a short message service (SMS).

In addition, the H/U 100 may receive permission for the payment request from the main user through the telematics server 200, when the sub user requests payment without payment rights.

When the main user receives the message indicating that the sub user requests payment without payment rights, the main user may configure the payment rights in the H/U 100 through the telematics server 200. The H/U 100 may request payment from the payment server upon receiving the payment rights of the main user.

The payment method and system of the vehicle according to the present disclosure have the following effects.

First, a main user who mainly uses the vehicle may deposit money into a virtual account, through which payment may be made in the vehicle, and a sub user who uses the vehicle may freely make payment within a geofence area.

Second, since payment may be made only within the geofence area, it is possible to drive the vehicle while making payment in the vehicle.

The present disclosure may be implemented as code that can be written to a computer-readable recording medium and can thus be read by a computer. Examples of the computer-readable recording medium may include a hard disk drive (HDD), a solid state drive (SSD), a silicon disk drive (SDD), a ROM, a RAM, a CD-ROM, a magnetic tape, a floppy disk, an optical data storage, and a carrier wave (e.g., data transmission over the Internet).

The computer-readable recording medium can be distributed over a plurality of computer systems connected to a network so that computer-readable code is written thereto and executed therefrom in a decentralized manner. Functional programs, code, and code segments needed to realize some forms of the present disclosure herein can be construed by one of ordinary skill in the art.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of making payment in a vehicle, the method comprising:
determining, with a head unit (H/U), whether a user of the vehicle is either a main user or a sub user;
receiving, with the H/U, location information of the vehicle;
determining, with the H/U, a category of a point of interest (POI) and payment rights based on the location information of the vehicle and the user of the vehicle, wherein the category of the POI is determined based on the location information of the vehicle, and wherein the payment rights is predetermined depending on the category of the POI; and
attempting to make payment, with the H/U, through a payment server based on the payment rights.

2. The method according to claim 1, further comprising:
registering, with a management server, the main user and the sub user.

3. The method according to claim 1, further comprising:
configuring, with the H/U, the category of the POI of the user; and
configuring, with the H/U, the payment rights based on the category of the POI of the user.

4. The method according to claim 3, wherein configuring the category of the POI of the user comprises:
when it is determined that the user of the vehicle is the main user, allowing configuration of the category of the POI of the user and the payment rights, wherein the payment rights is based on the category of the POI of the user.

5. The method according to claim 3, wherein configuring the category of the POI of the user comprises:
when it is determined that the user of the vehicle is the sub user, disallowing configuration of the category of the POI of the user and the payment rights, wherein the payment rights is based on the category of the POI of the user.

6. The method according to claim 1, wherein determining the category of the POI is based on whether the vehicle is within a predetermined geofence area.

7. The method according to claim 1, wherein attempting to make payment through the payment server based on the payment rights comprises:
when it is determined that the user of the vehicle is the main user, allowing payment at any place corresponding to the location information, wherein the place is capable of processing payment.

8. The method according to claim 1, wherein attempting to make payment through the payment server based on the payment rights comprises:
when the sub user attempts to make payment, notifying, with the H/U, the main user.

9. The method according to claim 1, wherein attempting to make payment through the payment server based on the payment rights further comprises:
when the sub user attempts to payment without the payment rights, receiving permission from the main user through a telematics server.

10. A computer-readable recording medium having a program recorded thereon, the program to direct a processor to perform acts of:
determining, with a head unit (H/U), whether a user of the vehicle is either a main user or a sub user;
receiving, with the H/U, location information of the vehicle;
determining, with the H/U, a category of a point of interest (POI) and payment rights based on the location information of the vehicle and the user of the vehicle, wherein the category of the POI is determined based on the location information of the vehicle, and wherein the payment rights is predetermined depending on the category of the POI; and
attempting to make payment, with the H/U, through a payment server based on the payment rights.

11. A system for making payment in a vehicle, the system comprising:
a head unit (H/U) configured to:
determine whether a user of the vehicle is either a main user or a sub user;
receive location information of the vehicle; and
determine a category of a point of interest (POI) and payment rights based on the location information of the vehicle and the user of the vehicle, wherein the category of the POI is determined based on the location information of the vehicle, and wherein the payment rights is predetermined depending on the category of the POI; and
a payment server, wherein the H/U attempts to make payment through the payment server based on the payment rights.

12. The system according to claim 11, further comprising a management server configured to register the main user and the sub user.

13. The system according to claim 11, wherein the H/U configures the category of the POI of the user and configures the payment rights based on the category of the POI of the user.

14. The system according to claim 13, wherein, when it is determined that the user of the vehicle is the main user, the H/U allows configuration of the category of the POI of the user and the payment rights, wherein the payment rights is based on the category of the POI of the user.

15. The system according to claim 13, wherein, when it is determined that the user of the vehicle is the sub user, the H/U disallows configuration of the category of the POI of the user and the payment rights, wherein the payment rights is based on the category of the POI of the user.

16. The system according to claim 11, wherein the H/U is configured to determine the category of the POI based on whether the vehicle is within a predetermined geofence area.

17. The system according to claim 11, wherein, when it is determined that the user of the vehicle is the main user, the H/U is configured to make payment at any place corresponding to the location information, wherein the place is capable of processing payment.

18. The system according to claim 11, wherein, when the sub user attempts to make payment, the H/U is configured to notify the main user.

19. The system according to claim 18, further comprising:
a telematics server configured to perform wireless communication with the vehicle, wherein, when the sub user attempts to make payment without the payment rights, the telematics server is configured to receive permission from the main user through the telematics server.
